(19) United States
(12) Patent Application Publication
(10) Pub. No.: US 2002/0165938 A1
(43) Pub. Date: Nov. 7, 2002

(54) Service server

(75) Inventor: Wolfgang Lautenschlager, Weissach-Flacht (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/115,082

(22) Filed: Apr. 4, 2002

(30) Foreign Application Priority Data
Apr. 21, 2001 (DE) 101 19 551.6

(51) Int. Cl. G06F 15/16

(52) U.S. Cl. 709/217; 709/228

(57) ABSTRACT

The invention relates to a method of providing a service via a communications network, wherein, in the method, a service server that furnishes the service for the service user is accessed via the communications network. Furthermore, the invention relates to a service server for performing the method. As a result of interaction between a terminal of the service user and the service server via the communications network, data are specified relating to a user-specific journey of the service user and are stored in a user-specific data record of the service user. Localization data that describe the whereabouts of a mobile terminal of the service user are transmitted via the communications network to the service server. The service server correlates the whereabouts of the mobile terminal with the user-specific journey by means of the received localization data and by means of the data, stored in the user-specific data record, relating to a user-specific journey of the service user and calculates a correlation result therefrom.

### BACKGROUND OF THE INVENTION

The invention is based on a priority application Ser. No. 101 19 551.6 which is hereby incorporated by reference.

The invention relates to a method of providing a service via a communications network, wherein, in the method, a service server that furnishes the service for the service user is accessed via the communications network. The invention furthermore relates to a service server for performing the method.

The invention proceeds from a system, such as that described, for example, in DE 19626114.

Said system provides subscribers having specially configured mobile terminals with a service by means of which they are individually warned of traffic hold-ups The specially configured mobile terminals are navigation systems for vehicles that are provided with a mobile-radio receiver. If a mobile-radio fixed station receives a hold-up message that describes the position of a traffic hold-up, it transmits broadcasting-type hold-up messages to all the mobile-radio terminals situated in the vicinity.

The specially configured terminals have a GPS localization device (GPS=global positioning system). By means of said device, the terminals determine whether the traffic hold-up described by a hold-up message is situated in the vicinity of the terminal. If this is the case, a special message is delivered to the vehicle user.

### SUMMARY OF THE INVENTION

The object of the invention is to improve the technical performance of such systems.

Said object is achieved by a method according to the teaching of claim 1 and also by a service server according to the teaching of claim 8.

In this connection, the invention is based on the idea of providing service users with a network service that makes it possible for service users to specify in a preparation phase user-specific journeys to the service. By means of received localization data, the network service correlates the whereabouts of a subscriber's mobile terminal with the specified user-specific journey and calculates a correlation result therefrom. Said correlation result then forms the basis of one or more further network services.

Advantageous refinements of the invention are to be found in the subclaims.

### BRIEF DESCRIPTION OF THE DRAWINGS

The invention is explained below by way of example by reference to a plurality of exemplary embodiments with the aid of the accompanying drawings.

FIG. 1 shows a communications system having a service server according to the invention.

FIG. 2 shows a functional diagram of the service server according to FIG. 1.

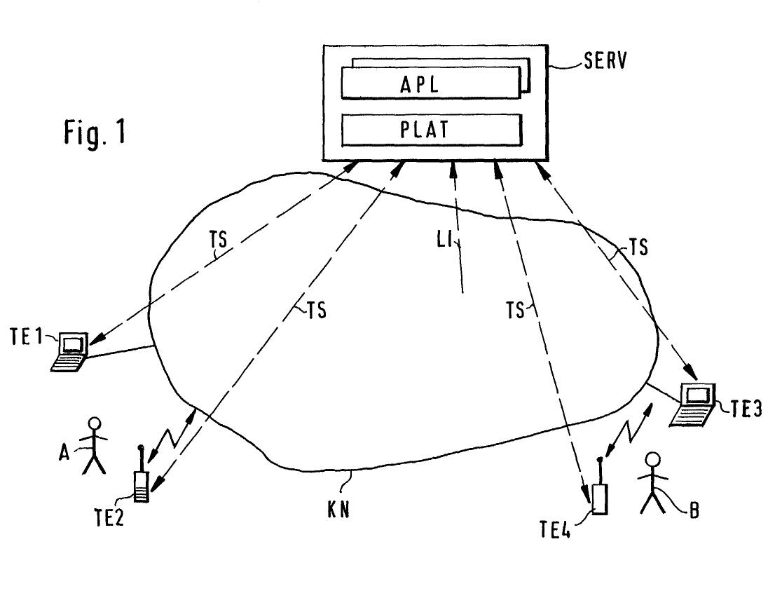

FIG. 1 shows a communications network KN, four terminals TE1 to TW4 and a service server SERV.

The communications network KN is configured in such a way that it makes possible the communication between the terminals TE1 to TE4, on the one hand, and the service server SERV, on the other. In the simplest case, the communications network KN is a standard telephone network that comprises a plurality of mutually connected subnetworks that may be assigned to different network levels. It is advantageous that the communications network KN also includes, furthermore, the function of a data network. The communications network KN may, for example, comprise one or more optical backbone networks, one or more access networks (for example, cable networks, mobile-radio networks), one or more IP (IP=Internet protocol) superimposing thereon or PSTN (PSTN=public switched telephone network) networks. The precise structure of the communications networks KN1 to KN3 is advantageously to be matched to the communications services needed by the terminals TE1 to TE4.

Of the terminals that communicate with the communications network KN, only the terminals TE1 to TE4 are shown by way of example in FIG. 1.

The terminals TE1 and TE3 are each a computer having an interface card for data communication or for mobile data communication. It is, however, also possible for said terminals to be telephone terminals, for example telephones or mobile-radio telephones, or any other type of communications terminals, for example multimedia terminals for speech, data and/or video communication.

The terminals TE2 and TE4 are each a mobile terminal that communicates with the communications network KN via a radio interface. Said terminal preferably communicates via a cellular radio network, for example according to the GSM (global system for mobile communication) standard or the UMTS (universal mobile telecommunications system) standard that is, in this respect, part of the communications network KN. Said terminals may be terminals that serve solely for speech communication. However, said terminals may also be terminals that also serve in addition for video and/or data communication and are equipped with appropriate additional components such as an image converter and an image-reproduction device.

The server SERV provides service users with one or more services via the communications network KN. In this connection, the server SERV is preferably assigned to a network operator that is independent of the network operators of the communications network KN. It is, however, also possible for the server SERV to be assigned to a network operator and to be operated by the latter.

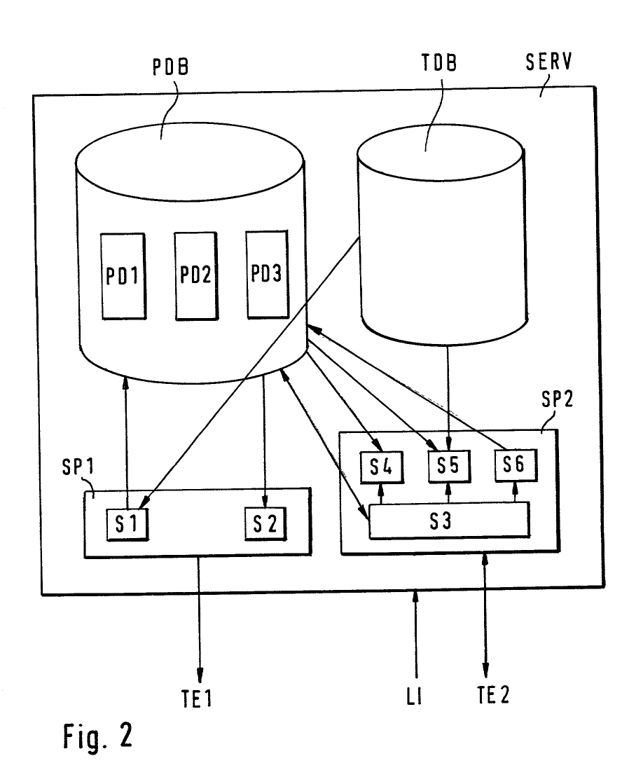

The service server SERV comprises one or more computers (hardware platform) connected via a communications network, a software platform superimposing on said hardware platform, for example comprising operating system, database system, middleware components and an ORB (ORB=object request broker), for example a CORBA (CORBA=common object request broker architecture) platform, and a plurality of application programs superimposing on said software platform. By running application programs APL on the software platform and hardware platform PLAT of the service server SERV, the service server SERV implements, in particular, the functions that are described below by reference to FIG. 2 and that are furnished by the interaction of the control means of the server SERV, that is to say hardware platform, software platform and application programs, therewith.

The terminals TE1 and TE2 are assigned to the service user A, and the terminals TE3 and TE4 to the service user B. By means of the terminals TE1 and TE2, the service user A accesses, via the communications network KN, the service server SERV, which then furnishes the service, described below, for the service user (A):

In a preparation phase, data relating to a user-specific journey of the service user A is specified by interaction TS between the terminal TE1 of the service user A and the service server SERV via the communications network KN. Said data are then stored in a user-specific data record of the service user A by the service server SERV.

In a second phase, an operating phase, localization data LI that describe the whereabouts of the mobile terminal TE are continuously communicated to the service server SERV via the communications network KN. By means of the received localization data LI and by means of the data, stored in the user-specific data record, relating to a user-specific journey of the service user, the service server SERV then correlates the whereabouts of the mobile terminal TE2 with the user-specific journey stored in the user-specific data record of the service user A and calculates a correlation result therefrom.

From the correlation result, the service server SERV calculates, for example, items of route guidance information. The calculated items of route guidance information are transmitted by the service server SERV to the mobile terminal TE2 via the communications network KN as part of an interaction TS.

The detailed mode of operation of the service server SERV is explained below by reference to FIG. 2.

FIG. 2 shows a functional diagram of the service server SERV. The service server SERV has, from a functional point of view, two databases PDB and TDB and two service control units SP1 and SP2 having the service-control functions S1 and S2, or S3, S4, S5 and S6, respectively.

In the databases PDB, a plurality of user-specific data records are serviced, of which three data records PD1 to PD3 are shown in FIG. 2 by way of example. It is also possible, of course, for only one user-specific data record to be serviced in the database PDB. In this connection, user-specific means that the data of the respective data record can be specified at least partly by the assigned service user.

Each of the data sets PD1 to PD3 is assigned to another service user. Thus, the data record PD1 is assigned, for example, to the service user A and the data record PD2 to the service user B. Each of the data records PD1 to PD3 preferably contains data relating to a single user-specific journey of the assigned service user, but it may also contain data relating to a plurality of user-specific journeys of the assigned service user.

Furthermore, it is also possible for two or more user-specific data records of a data user to be serviced in the database PDB, various user-specific journeys of the same service user being specified in the two or more user-specific data records.

Stored in each of the user-specific data records PD1 to PD3 are data that describe a particular user-specific journey of the assigned service user. Said data consequently fits in location, on the one hand, the geographical course of the journey in which they include, for example, the geographical position of a plurality of, or a multiplicity of, route points of the user-specific journey. Furthermore, it is also possible for, for each of the route points, a set of parameters and/or assigned items of information also to be stored in the respective data record. In addition to those data that describe a user-specific journey of a service user, a journey-specific parameter set and also items of information relating to it are advantageously also stored in the particular data record, to which service user the data record is assigned.

Furthermore, it is advantageous that the database PDB comprises, in addition to such user-specific data records, also a further data record for each registered service user in which service-user-specific data, for example, a user profile, are stored.

The databases TDB contain data relating to a multiplicity of planned journeys, items of information relating to said journeys, and also position-dependent items of information that have, for example, a geographical, historical or economical content and relate in some way to particular positions or regions. Such items of information may comprise, in addition to text, also items of audio and video information.

It is also possible for the database TDB not to be part of a service server SERV and is installed in one or more other computers that are connected to the service server SERV via a communications network. The database TDB may also be formed by a multiplicity of databases that each comprise part of the content of the database TDB.

The service control unit SP1 essentially furnishes functions for preparing and assessing a user-specific journey, whereas the service control unit SP2 furnishes functions for supporting a service user during the performing of a user-specific journey. In addition, various terminals advantageously access the service control units SP1 and SP2, for example a PC having WEB browser and a large display screen access the service control unit SP1 and a GSM mobile-radio telephone accesses the user control unit SP2. The user interfaces of the service control units SP1 and SP2 are consequently, as a rule, completely different.

Should, in particular, UMTS mobile telephones not also be mentioned here?

The detailed mode of operation of the service control units SP1 and SP2 and of the service control functions S1 to S6 is described below.

The service control unit SP1 furnishes the service control functions S1 and S2 and provides a user interface for said service control functions. Preferably, the service user communicates with the control unit SP by means of the IP (IP=Internet protocol) protocol and application protocols imposing thereon, with the result that it is possible for a service user, for example, to access, via a standard Internet user interface by means of a standard WEB browser, the service control unit SP1 to which a special IP address is assigned in this respect.

A service user accesses the service control unit SP1 by means of a terminal, for example by means of the terminal TE1.

The service control unit SP1 checks, by means of accessing the database PDB, whether the service user is registered for the service provided by the service server SERV and ascertains the identity of the service user. For this purpose, it advantageously performs an authentication procedure. It is also possible to dispense with the checking of the registration and/or the identification.

The service user can subsequently initiate the performance of the service control functions S1 or S2.

The service control function S1 makes it possible, by means of the interaction TS between the service control function S1 and the service user's terminal via the communications network KN, for data to be specified relating to a user-specific journey of the service user and for said data to be stored in a user-specific data record of the service user.

The service control function S1 first checks whether a user-specific journey for which a data record is already stored in the database PDB is to be modified or whether a new user-specific journey is to be specified. If a new journey is to be specified, it installs an appropriate new user-specific data record in the database PDB.

To specify the journey, the data described above as part of the database PDB are stipulated, ascertained and stored in the assigned user-specific data record by the service control function S1 in response to appropriate control commands from the service user's terminal. In this connection, the service user can also access via the service control function S1 the data stored in the database TDB have such data delivered via the communications network KN and copy such data entirely, partly or in modified form into the user-specific data record. In this connection, it is, of course, also possible for only a pointer to or a link to the data in the database TDB to be stored in the user-specific data record. In this way, the geographical course of the journey is determined by the service control function S1 and stored in the user-specific data record, for example as a set of geographical route points. Furthermore, a set of parameters and/or assigned items of information relating to locations in the geographical course of the journey are also specified by interaction between the terminal of the service user and the service control function S1. In this connection, such items of information are preferably collected from the database TDB.

Furthermore, it is advantageous that the service control function S1 assigns a specific indicator or a specific network address or service indicator to each user-specific journey and transmits said indicator, network address or service indicator to the terminal TE1 for the purpose of later identifying the journey. In this connection, said data may serve to identify the journey rapidly, in particular, in the event of later access by means of a mobile terminal.

The service control function S2 makes it possible for items of information transmitted via the communications network KN by the mobile terminal during a journey and stored by the service control function S5 by means of an assignment in accordance with the correlation result to be transmitted via the communication network KN at the request of the service server SERV to the service user's terminal TE1. The precise mode of operation of the service control function S2 is explained in connection with the mode of operation of the service control function S6.

The service control unit SP2 furnishes the service control functions S3 to S6 and provides a user interface for said service control functions. The service user communicates with the service control unit SP1 by means of a mobile terminal. In principle, it is possible for the mobile terminal to access the service control unit SP2 in exactly the same way as described above with reference to the service control unit SP1. In this case, it is then also possible to integrate the service control functions S3 to S6 in the service control unit SP1.

On the other hand, it is, however, advantageous to implement one or more of the following access possibilities in the service control unit SP2 depending on the particular mobile terminal:

The service control unit SP2 may implement an IN (IN=intelligent network) service control function that communicates with the switching centres of the communications network KN via the INAP (INAP=intelligent network application part) protocol. The communication between service user and service control unit SP2 may take place, for example, by means of voice announcements, audio messages or speech recognition.

Is the following description sufficiently wide????

The communication between service control unit SP2 and the mobile terminal can take place by means of the SMS (SMS=short message service) service.

The communication between service control unit SP2 and the mobile terminal can take place by means of WAP (=wireless application protocol) or comparable services.

The communication between service control unit SP2 and the mobile terminal can take place by means of data communication via GPRS (=general packet radio services) or UMTS.

The service control function S3 calculates a correlation result and makes said result available to the service control functions S4 to S6.

The service control function S3 receives for this purpose localization data LI that describe the whereabouts of a service user's mobile terminal, in this case the terminal TE2. In this connection, the localization data LI may be continuously transmitted via the communications network KN to the service control function S3. It is also possible, however, for the localization data LI also to be transmitted only to the service control function S3 if the mobile terminal TE2 requests items of route guidance information.

The localization data may be ascertained, on the one hand, by the mobile terminal TE2, for example by means of an integrated GPRS receiver, and then transmitted by the mobile terminal TE2 to the service control unit SP2. It is, however, also possible for the localization data LI to be ascertained by a localization service of the communications network KN, which localization service then transmits said data to the service server SERV. Such a localization service may ascertain the geographical position of the mobile terminal TE2, for example, by means of determining the radio cell in which the terminal TE2 is currently located and of evaluating the field strengths of the surrounding radio cells.

If the service control function S3 receives via the communications network (KN) localization data that describe the whereabouts of a mobile terminal, the service control function S3 advantageously first checks whether and to which user-specific journey of which service user said localization data are assigned. Consequently, it also selects those user-specific data records PD1 to PD3 that are serviced in the database PDB and to which the localization data are to be assigned.

It is advantageous to provide such a function centrally for all the service control functions S3 to S6 or to provide them in each of the service control functions S3 to S6, and to perform said function in each case prior to furnishing the respective services furnished by the service control functions S3 to S6.

In this connection, the service control unit SP2 may ascertain whether the terminal with which it is interacting is assigned to one of the registered service users and to which of the registered service users it is assigned. Furthermore, it may ascertain to which of the various user-specific journeys this interaction of a terminal of the service user is assigned.

This is possible, for example, in that the service control function S1 assigns a specific indicator or a specific network address or service indicator to every user-specific journey and has transmitted said indicator, network address or service indicator to the service user for subsequent identification of the journey. The localization data or the interaction TS then contain said indicator, they are transmitted to or directed at said network address, or the service control unit SP2 is triggered by means of said service indicator for the reception of localization data or for the interaction TS. In this way, a clear assignment of localization data is then possible to a certain user-specific journey and, consequently, to a certain user-specific data record.

Furthermore, it is also possible for the service user A already to stipulate an assignment between the specified user-specific journey and a mobile terminal as part of the interaction TS with the service control function S1 and to recognize the service control unit S3 of said mobile terminal by means of its subscriber connection indicator and, consequently, to assign the localization data to a user-specific data record.

The service control function S3 correlates, by means of the received localization data LI and by means of the data stored in the ascertained, assigned user-specific data record, in this case the user-specific data record PD1, relating to a user-specific journey of the service user A, the whereabouts of the mobile terminal TE2 having the user-specific journey. During this correlation, the service control function S3 compares the geographical whereabouts, specified in the localization data, of the mobile terminal TE2 having the geographical course of the user-specific journey that is stored in the data record PD1. During this comparison, the service control function calculates which point in the course of the user-specific journey the geographical whereabouts of the mobile terminal is nearest. In this connection, it is advantageous also to bear in mind the probability of error in the geographical whereabouts (for example, due to measurement inaccuracy . . . ), on the one hand, and the probability of error in the specified journey (as specified precisely and in detail) in this calculation. If the geographical course of the user-specific journey is specified in the user-specific data record by means of a set of geographical route points, the precise course of the user-specific journey is determined in this calculation by means of interpolation and/or by means of correlation with the detailed geographical map.

As the result of the correlation of the whereabouts of the mobile terminal TE2 with the user-specific journey, the service control function S3 calculates that location in the course of the user-specific journey that is nearest the geographical whereabouts of the mobile terminal. The result may consequently consist in indicating a route point specified in the data record PD1 or a new route point ascertained as described above. Furthermore, it is also possible for data relating to one or more routes to be ascertained from the geographical whereabouts of the mobile terminal back to the specified user-specific journey as the result of the correlation. In particular, a further correlation with a detailed geographical map is advantageous for this purpose.

The correlation results are used by one or more further service control functions, in this case, for example, by the service control functions S4 to S6. It is, of course, also possible to use the correlation results for services other than those described for the service control functions S4 to S6. Furthermore, it is advantageous to store the correlation results in the assigned user-specific data record. In this connection, stored correlation results can also be reused to calculate further correlation results or to calculate items of route guidance information.

The service control function S4 calculates items of route guidance information from the correlation result. The calculation of the items of route guidance information by the service control function S4 may take place, on the one hand, every time localization data are received, only in response to a control message on the part of the mobile terminal or as a function of parameters of the user-specific data record (for example, at certain time intervals, at certain locations in the course of the user-specific journey).

Items of route guidance information are, for example, items of information about the direction in which the service user has to go or to travel in order to follow the course of the user-specific journey or to get back to the user-specific journey. Said items of information are calculated analogously to the way described above from the correlation result and the data, stored in the data record, relating to the user-specific journey.

The calculated items of route guidance information are then transmitted by the service control function S4 to the service user's mobile terminal TE2 via the communications network KN. Said transmission may take place, as already described above, by means of voice announcement, displayed text, displayed graphics, SMS message or WAP page.

The service control function S5 selects position-dependent items of information by means of the correlation result and transmits the selected items of information to the mobile terminal TE2. The service control function S5 may furnish said function, on the one hand, every time localization data are received, furnish it in response to a control message on the part of the mobile terminal or furnish it as a function of parameters of the user-specific data record (for example, at certain time intervals, at certain locations in the course of the user-specific journey). In this connection, delivery may take place as in the case of the service control function S4.

The service control function S5 may make a selection between position-dependent items of information by means of the correlation result, which items are specified in the user-specific data record PD1 of the service user A, as described above. At the request of the mobile terminal TE2, for example, the items of information are selected that are assigned to the nearest route point according to the correlation result. In this connection, it is also possible for a message to be transmitted to the terminal TE2 by the service control function S4 if, according to the correlation result, a location has been reached in the course of the user-specific journey that is stored in the data record PD1 and for which such position-dependent items of information are stored in the data record PD1.

Furthermore, it is also possible for the service control function S5 to make a selection between position-dependent items of information that are stored in the database TDB by means of a correlation result and, advantageously, also by means of a user profile assigned to the service user.

The service control functions S6 make it possible for the service user of the mobile terminal TE2 to transmit items of information to the service server SERV via the communications network KN. Such items of information may be voice courses, an audio course, a video course, image courses or text courses. The service control function S6 stores the items of information in the assigned user-specific data record with an assignment in accordance with the correlation result. It thus arranges, for example, such received items of information in an order in accordance with the course of the user-specific journey by means of the correlation result or it assigns them specifically to a location in the course of the user-specific journey.

It is possible for the service user A to access the items of information stored in this way in the user-specific data record PD1 by means of the service control function S2.

1. Method of providing a service via a communications network, wherein, in the method, a service server that furnishes the service for the service user is accessed via the communications network, wherein, as a result of interaction between a terminal of the service user and the service server via the communications network, data are specified relating to a user-specific journey of the service user and are stored in a user-specific data record of the service user, in that localization data that describe the whereabouts of a mobile terminal of the service user are transmitted to the service server via the communications network, and in that the service server correlates the whereabouts of the mobile terminal with the user-specific journey by means of the received localization data and by means of the data, stored in the user-specific data record, relating to a user-specific journey of the service user and calculates a correlation result therefrom.

2. Method according to claim 1, wherein the service server calculates items of route guidance information by means of the correlation result, and in that the service server transmits the calculated items of route guidance information to the mobile terminal of the service user via the communications network.

3. Method according to claim 1, wherein the service server selects position-dependent items of information by means of the correlation result and transmits selected items of information to the mobile terminal.

4. Method according to claim 3, wherein the service server makes a selection between position-dependent items of information by means of the correlation result that are specified in the user-specific data record of the service user.

5. Method according to claim 3, wherein the service server makes a selection between position-dependent items of information that have been stored in one or more databases by means of the correlation result and by means of a user profile.

6. Method according to claim 1, wherein items of information are transmitted to the service server by the mobile terminal via the communications network and are stored by the service server in the assigned user-specific data record with an assignment in accordance with the correlation result.

7. Method according to claim 1 or claim 6, wherein items of information transmitted by the mobile terminal via the communications network and stored with an assignment in accordance with the correlation result are transmitted at the request of the service server to the terminal of the service user.

8. Service server for providing a service via a communications network, wherein the service server is configured in such a way that it specifies, by means of interaction with a terminal of a service user via the communications network, data relating to a user-specific journey of the service user and stores said data in a user-specific data record of the service user, and in that the service server is furthermore configured in such a way that, if it receives localization data that describe the whereabouts of a mobile terminal of the service user via the communications network it correlates, by means of the received localization data and by means of the data stored in the user-specific data record relating to a user-specific journey of the service user, it correlates the whereabouts of the mobile terminal with the user-specific journey and calculates a correlation result therefrom.

9. Service server according to claim 8, wherein the service server is furthermore configured in such a way that the service server calculates items of route guidance information by means of the correlation result and it transmits the calculated items of route guidance information to the mobile terminal of the service user via the communications network.

10. Service server according to claim 8 or claim 9, wherein the service server is furthermore configured in such a way that it selects position-dependent items of information by means of the correlation result and transmits selected items of information to the mobile terminal.

11. Service server according to one of claims 8 to 10, wherein the service server is furthermore configured in such a way that items of information transmitted by the mobile terminal via the communications network and stored with an assignment in accordance with the correlation result are transmitted at the request of the service server to a terminal of the service user.

12. Service server according to claim 8, wherein the service server is provided with a data bank in which user-specific data records are serviced by two or more service users, and in that the service server is furthermore configured in such a way that it ascertains whether a terminal with which it is interacting is assigned to one of the two or more service users and to which of the two or more service users it is assigned.

13. Service server according to claim 8, wherein the service server is provided with a data bank in which two or more user-specific data records of a service user are serviced, wherein various user-specific journeys of the same service user are specified in the two or more user-specific data records, and in that the service server is furthermore configured so that it ascertains to which of said various user-specific journeys an interaction with a terminal of the service user is assigned.
